(19) United States
(12) Patent Application Publication
(10) Pub. No.: US 2002/0057898 A1
(43) Pub. Date: May 16, 2002

(54) METHOD AND APPARATUS FOR TRICK PLAY OF BITSTREAM DATA

(76) Inventor: JAMES OLIVER NORMILE, WOODSIDE, CA (US)

Correspondence Address: Daniel Hopen, 656 Saturn Avenue, Fremont, CA, 94539, US

(21) Appl. No.: 08/995,105

(22) Filed: Dec. 19, 1997

(51) Int. Cl. H04N 5/783; H04N 5/91; H04N 7/26

(52) U.S. Cl. 386/68; 386/111

(57) ABSTRACT

An apparatus for a trick play video player and methods of operating the same result in a video player that provides a compressed data stream of output image data for later playback. The trick play video player comprises a frame creator which receives output image data and creates a reference frame from the output image data. A data stream storage is coupled to the frame creator configured to store the compressed data stream which follows the reference frame. The reference frame and the compressed data stream is decoded to replay the output image data.

### BACKGROUND OF THE INVENTION

1. Field of the Invention

The present invention relates to decoding of encoded compressed bitstream video images and more particularly to recording and random accessing of the decoded video images.

2. Description of the Related Arts

As the Internet becomes more and more popular, more and more data are being transferred using the Internet. The Internet and other channels of communication have bandwidth limitations. Data compression is often used to maximize data transmission over such limited bandwidth channels. Data compression in general and in particular of video data involves coding the information as prediction deltas relative to previously transmitted data. Although this prediction improves the efficiency of the video transmission, it makes it difficult to directly store a portion of the video transmission in a form suitable for later access.

The difficulty is compounded when a video stream is being received from a remote source via a communication channel. Such situations include video conferencing, broadcasts of major events, and other video streaming applications. In the television broadcast arena, video camera recorders (VCRs) have been developed to enable users to record and review broadcasted transmissions. Users of the VCRs are able to select which broadcast transmissions to record and are able to fast forward or rewind to a particular section of the recording. However, recording data transmissions which are compressed and encoded in a fashion that the current received information is based on predictive changes of previously transmitted information pose difficulties not encountered in the television broadcast arena. Each picture in the television arena is independent and may be recorded without regard to previously transmitted images unlike predictive encoded data.

Therefore, it is desirable to provide an apparatus and methods of operating the same which afford recordation and later access of an encoded compressed stream.

### SUMMARY OF THE INVENTION

The present invention provides an apparatus for trick play video players and methods for operating the same which afford access to encoded compressed images. The novel trick play video player is based on generating an independent bitstream from which the independent bitstream is later decoded for playback. Thus, according to one aspect of the invention, the trick play video player for creating a compressed data stream of output image data to provide later playback of captured compressed data comprises a frame creator which receives output image data and creates a reference frame from the output image data. A data stream storage coupled to the frame creator is configured to store the compressed data stream which follows the reference frame. The reference frame includes an intra coded frame which is encoded independent of previous output image data in the compressed data stream. The frame creator includes an encoder which encodes the output image data to provide an uncompressed reference frame. The uncompressed reference frame is stored in rgb, yuv, JPEG or other format.

According to another aspect of the invention, the data stream storage provides predicted compressed data in reference to an intra coded frame. The reference frame and the compressed data stored in the data stream storage comprise an independent data stream. A decoder coupled to the frame creator is configured to receive an initializing reference frame and decode the compressed data stream to provide the later playback of the captured compressed data. Thus, the independent data stream is loaded to initialize the decoder to enable playback of the stored compressed data.

According to yet another aspect of the invention, the frame creator includes a reference frame buffer which stores a plurality of reference frames at predetermined intervals. The data stream storage includes an indexor which generates an index of a start position of each video frame of the compressed data stream which follows the reference frames. A controller coupled to the frame creator and the data stream storage is configured to select a particular reference frame and a particular index corresponding to a video frame following the particular reference frame to the decoder to provide random access of the compressed data stream.

An apparatus and method for operating a trick play video player are provided whereby the trick play video player generates an independent encoded compressed bitstream that is decoded for later playback. Furthermore, random access to the encoded compressed bitstream is achieved by generating multiple reference frames and indexing the encoded compressed bitstream to determine corresponding images in the encoded compressed bitstream. Initializing the decoder from a particular reference frame and decoding the corresponding images which follow the reference frame affords random access to the encoded compressed bitstream.

Other aspects and advantages of the present invention can be seen upon review of the figures, the detailed description, and the claims which follow.

### BRIEF DESCRIPTION OF THE DRAWING

FIG. 1 illustrates a system level block diagram of a video conferencing system.

FIG. 2 illustrates a block diagram of a trick play video decoding system in accordance to the present invention.

FIG. 3 illustrates a block diagram of the trick player in accordance to the present invention.

FIG. 4 illustrates a block diagram of an alternative embodiment of a frame creator.

FIG. 5 illustrates a block diagram of an alternative embodiment of a bitstream data store.

FIG. 6 illustrates a flow diagram for accessing compressed bitstream data.

FIG. 7 illustrates a flow diagram for random access of compressed bitstream data.

### DETAILED DESCRIPTION OF THE INVENTION

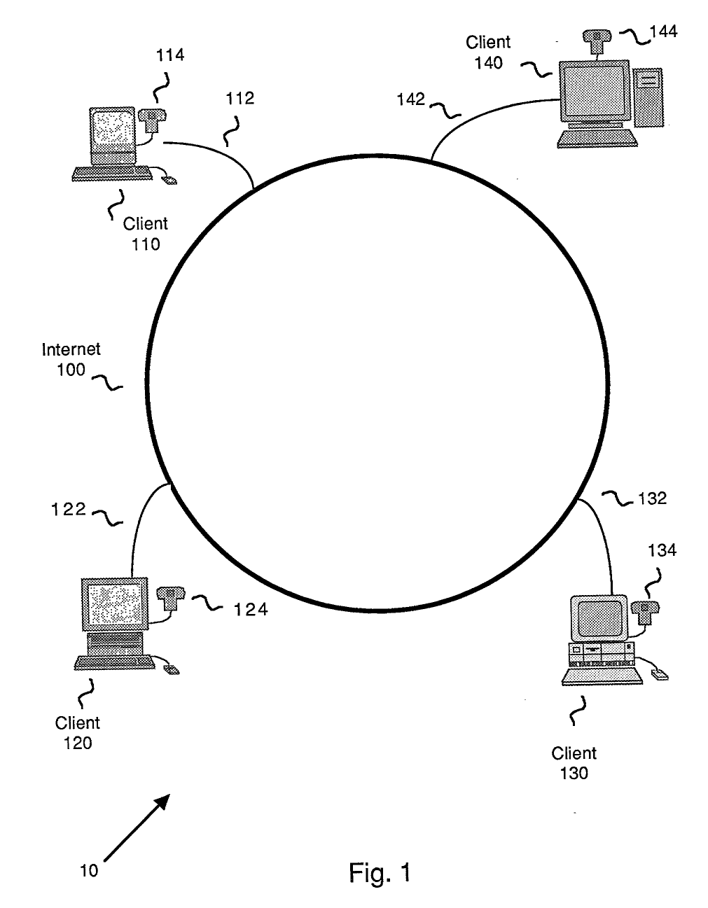

The invention will be described with respect to the Figures in which FIG. 1 generally shows a video conferencing system 10. The video conferencing system 10 includes an Internet 100, client 110, client 120, client 130, and client 140. The Internet 100 provides TCP/IP (Transmission Control Protocol over Internet Protocol). Other represented segments operating the TCP/IP including intranets and local area networks are also suitable.

Network connection 112 provides the client 110 access to the Internet 100. Network connection 122 provides the client 120 access to the Internet 100. Network connection 132 provides the client 130 access to the Internet 100. Network connection 142 provides the client 140 access to the Internet 100. Clients 110, 120, 130, and 140 include logic circuits that are programmed to perform a series of specifically identified operations for video conferencing on the Internet 100. Video camera 114 provides audio/video data from client 110 for transfer to another client on the Internet 100. Client 140 for example, is configured to receive the audio/video data from client 110 and transfers the audio/video data from camera 144 to client 110 on the Internet 100. Similarly, client 120 includes camera 124, and client 130 includes camera 134 for video conferencing on the Internet 100. Thus, clients 110, 120, 130, and 140 include video conferencing links via the Internet 100 to provide video conferencing between the clients.

The clients 110, 120, 130, and 140 include logic circuits that are programmed to perform a series of specifically identified operations for encoding and decoding compressed bitstream video data. Video encoding techniques such as H.261, H.263, H.263Plus, MPEG-4 (Motion Pictures Experts Group-4), and H.324 standards have been developed for use in video teleconferencing and video telephony applications and provide a plurality of display frames wherein each display frame includes a plurality of display blocks.

For example, each picture is divided into groups of blocks (GOBs). A group of blocks (GOB) includes multiples of 16 lines depending on the picture format. Each GOB is divided into macroblocks. A macroblock relates to 16 pixels by 16 pixels of y, the luminance, and the spatially corresponding 8 pixels by 8 pixels of u and v, the two color components. Further, a macroblock includes four luminance blocks and the two spatially corresponding color difference blocks. Each luminance or chrominance block relates to 8 pixels by 8 pixels of y, u or v. A more detailed description is contained in Document LBC-95-251 of the International Telecommunication Union Telecommunication Standardization Sector Study Group 15 entitled “Draft Recommendations H.263 (Video coding for low bitrate communication)”, contact Karel Rijkse, Tel: +31 70 332 8588; the Draft Recommendations H.263 (Video coding for low bitrate communication) is herein incorporated by reference in its entirety.

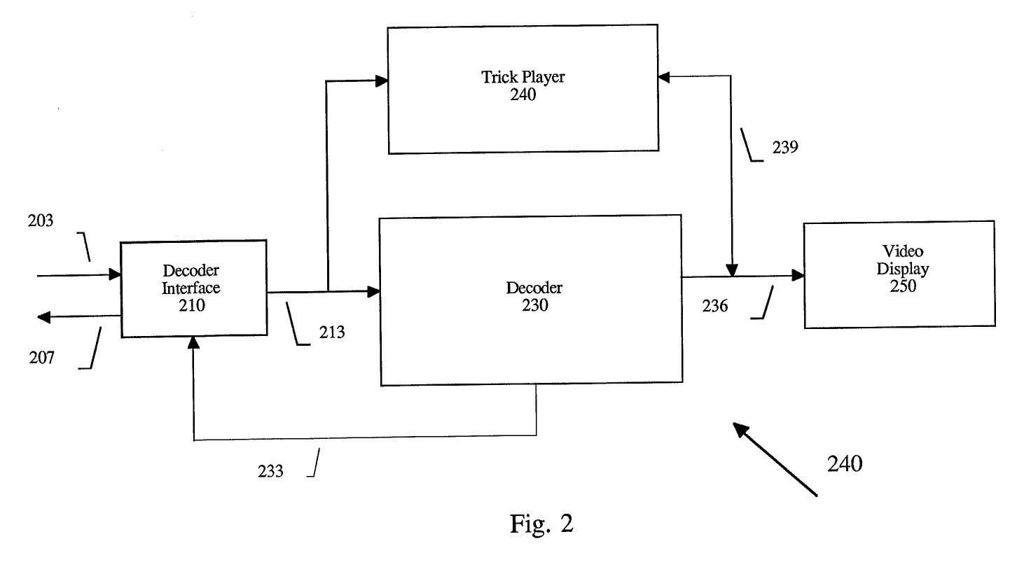

FIG. 2 shows a block diagram of a trick play video decoding system 20 for decoding and accessing variable length coded compressed bit streams according to the present invention. The trick play video decoding system 20 includes a decoder interface control/demultiplexer 210, a decoder 230, a trick player 240, and a video display 250. The control/demultiplexer 210 includes resources for comparing a locally generated cyclic redundancy check (CRC) with a received CRC of bitstream data received on line 203. If an error is detected from comparison of the locally generated CRC with the received CRC, the control/demultiplexer 210 requests a retransmission request on line 207. If no error is detected, the compressed bitstream data is transferred to the decoder 230 and the trick player 240 on line 213. The decoder 230 includes resources which decodes the bitstream data. The decoder 230 is described in U.S. patent application Ser. No. 08/618,847 entitled “A Method Of Lossy Decoding Of Bitstream Data” filed Mar. 20, 1996 and is herein incorporated by reference. The decoder 230 provides display data on line 236 for the video display 250.

Generally, the trick player 240 includes resources which afford replay of a portion of the received bitstream data. In an alternative embodiment, the trick player 240 include resources which afford random access of the received bitstream data. The trick player 240 receives decoded bitstream data from the decoder 230 on bi-directional line 239 and compressed bitstream data on line 213 in order to provide later access to the compressed bitstream data. Thus, the trick player 240 is able to operate in the background in another thread while the video display 250 operates on the display data from the decoder 230. The details for the replay and random access of the compressed bitstream data is disclosed in the FIGS. which follow.

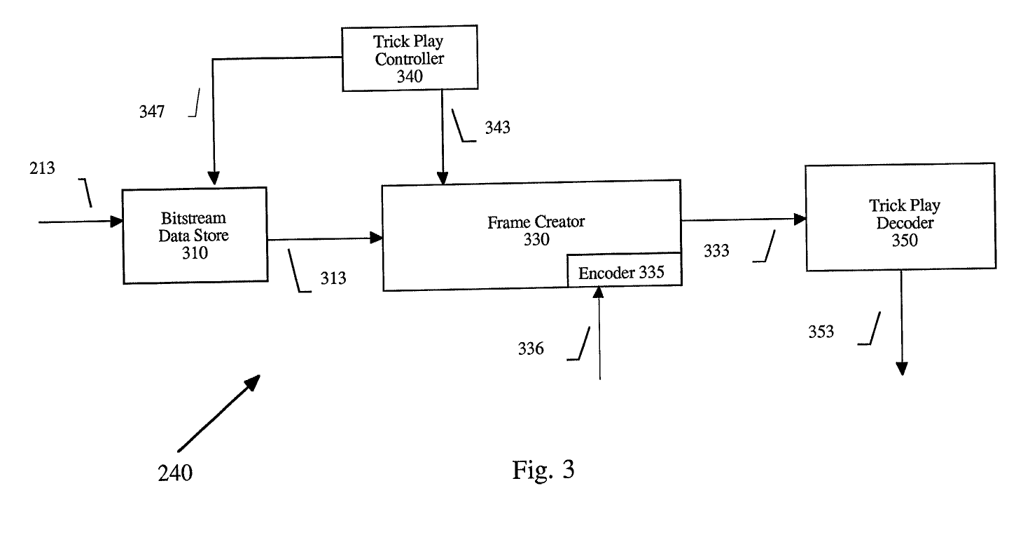

FIG. 3 shows a block diagram of the trick player 240 in accordance to the present invention. The trick player 240 includes a bitstream data store 310, a frame creator 330, a trick play controller 340, and a trick play decoder 350. The frame creator 330 receives a decoded output image on line 336 from the decoder 230. The frame creator 330 includes an encoder 335 which encodes the output image on line 336 to create a reference frame. Depending on the encoder 335, the reference frame may be encoded to either yuv, rgb (red, green, blue), JPEG (Joint Pictures Experts Group), MPEG-4 or other suitable format for the trick play video decoding system 20. When encoded in the yuv, rgb, JPEG, or other similar format, the reference frame is uncompressed. In the present embodiment, the encoder 335 encodes the reference frame as an intra frame compressed in the H263 format. The frame creator 330 includes resources which stores the encoded reference frame. The intra frame as encoded includes video data that is independent of other predictive deltas relative to previously transmitted video data.

Moreover, in order to more accurately encode the reference frame to better represent the decoded output image, the encoder 335 does multiple passes on the received decoded output image. For example, the encoder 335 modifies properties of frame quantizing to achieve the closest match to the decoded output image for the encoded reference frame.

In an alternative embodiment, the encoder 335 includes resources to convert H.263 format to MPEG-4 format which consists modifying the H263 syntax to conform with that of MPEG-4. Also, the encoder 335 may insert keyframes to complete the H.263 to MPEG-4 conversion.

The trick play controller 340 directs the frame creator 330 on line 343 to store the encoded reference frame. The trick play controller 340 also directs the bitstream data store 310 on line 347 to store compressed bitstream data associated with data following the stored reference frame. Thus, the frame creator 330 and the bitstream data store 310 provides an independent data stream of a portion of the received compressed bitstream being supplied from the control/demultiplexer 210 on line 213.

To replay the stored independent data stream, the frame creator 330 initializes the trick play decoder 350 with the reference frame and supplies the stored compressed bitstream data which followed the stored reference frame to the trick play decoder 350. Depending on the format of the reference frame, the trick play decoder 350 is initialized by loading the uncompressed rgb or yuv data or decoding the compressed H.263 or MPEG-4 encoded frame. Moreover, if the format of the reference frame is an compressed intra frame, the trick play decoder 350 is initialized by decoding the compressed intra frame. As the stored reference frame initializes the trick play decoder 350, the stored compressed bitstream data is decoded by the trick play decoder 350 to provide output image data on line 353 to the video display 250. For sake of clarity, it is noted that lines 336 and 353 of FIG. 3 are depicted by the bi-directional line 239 of FIG. 2. Furthermore, the trick play decoder 350 is similar to the decoder 230. Those skilled in the art will realize that the output of the frame creator 330 on line 333 can be redirected to the input of decoder 230 thereby eliminating the need for a second decoder such as the trick play decoder 350.

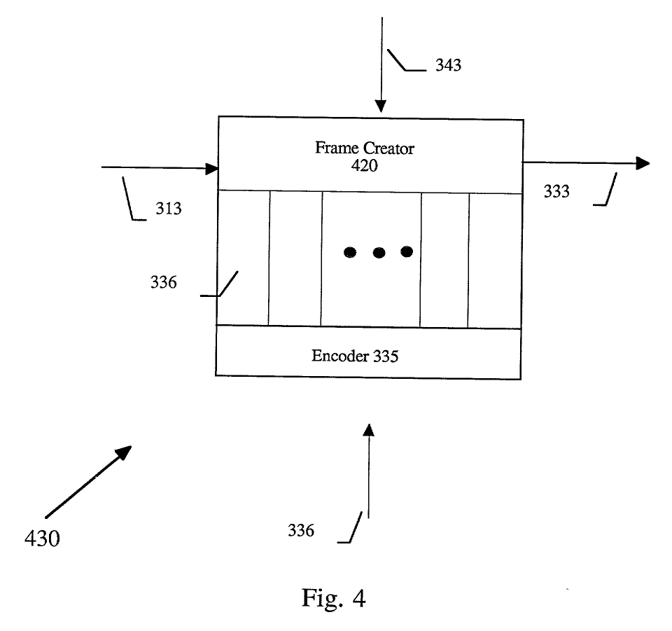

In an alternative embodiment, the trick play video decoding system 20 affords random access of the stored compressed bitstream. FIG. 4 shows an alternative embodiment of the frame creator 330. Frame creator buffer 430 is similar to frame creator 330 but includes a plurality of storage buffers 336 for storing a plurality of reference frames. Thus, the frame creator buffer 430 includes an encoder 335 for encoding multiple frames of output image data received from line 336. The frame creator 420 receives stored bitstream data from line 313 and control signals from the trick play controller 340 on line 343, and provides reference frames and bitstream data on line 333 to the trick play decoder 350.

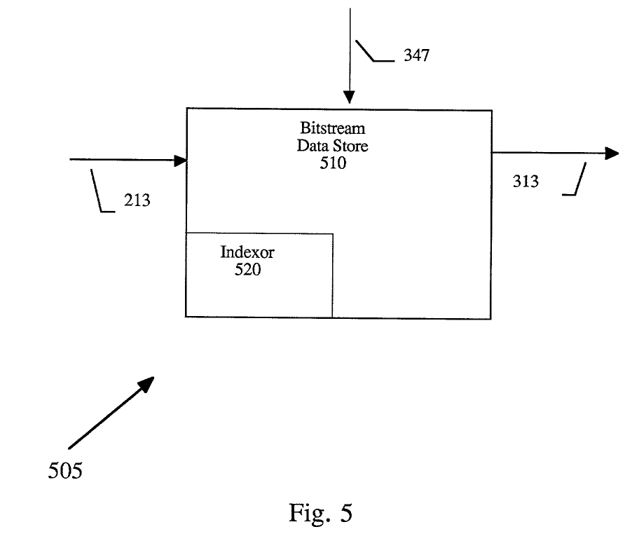

FIG. 5 shows an alternative embodiment of the bitstream data store 310 in order to effectuate random access of stored bitstream data. Bitstream data store with index 505 is similar to the bitstream data store 310 but includes an indexor 520 in addition to the bitstream data store 510. The indexor 520 provides an index of the start position of each video frame in the stored compressed bitstream. The indexor 520 scans the compressed bitstream for picture start codes in the bitstream. The picture start codes indicates the beginning of each video frame within the compressed bitstream. The bitstream data store 510 receives compressed bitstream data on line 213 and control signals from the trick play controller 340 on line 347 and provides compressed bitstream data on line 313. The compressed bitstream data being stored in the bitstream data store 510.

Random access of the stored bitstream data is achieved by generating and storing a plurality of reference frames to the frame creator buffer 430. At application dependent intervals, where more intervals affords shorter lapses between start frames, the encoder 335 of the frame creator buffer 430 encodes reference frames from the output display data received on line 336 and stores the reference frames in the storage buffers 336. The indexor 520 of the bitstream data store with index 505 indexes the compressed bitstream data associated with the encoded reference frames being stored in the storage buffers 336 of the frame creator buffer 430.

The trick play controller 340 selects a particular reference frame and refers to the indexes of the stored compressed bitstream to find a position that follows the selected reference frame. To effectuate playback of the selected reference frame, the frame creator 430 provides the selected reference frame to the trick play decoder 350 to initialize the decoder to enable the decoder to begin decoding the stored compressed bitstream from an index position which follows the decoded reference frame. Other positions within the stored compressed bitstream is similarly accessed by selecting a reference frame from the plurality of reference frames and an associated index to the selected reference frame in the compressed bitstream and initializing the trick play decoder 350 to begin decoding the compressed bitstream.

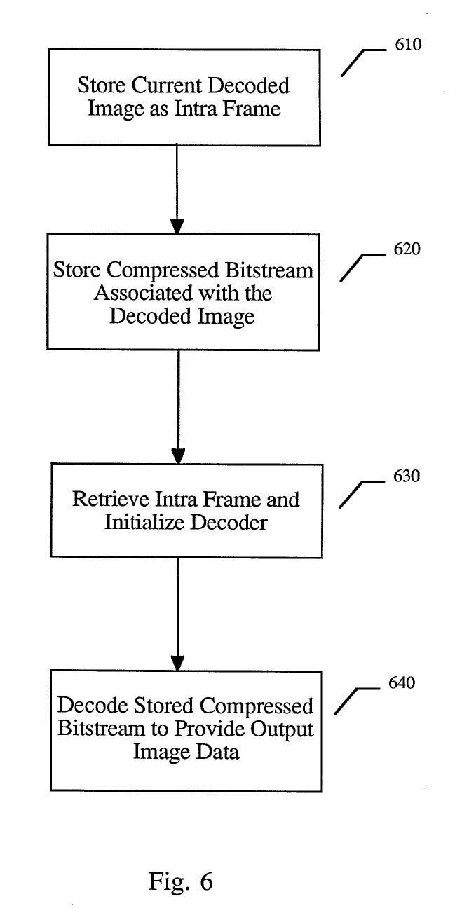

FIG. 6 illustrates a flow diagram of an embodiment for accessing a compressed bitstream. The flow diagram begins with step 610 in which the frame creator 330 stores the current decoded image as an intra frame. Encoding and storing the decoded image as an intra frame enables the frame creator 330 to initialize the trick play decoder 350 or other standard compatible decoder with the intra frame. In step 620, the bitstream data store 310 stores the compressed bitstream associated with the decoded image. In step 630, the frame creator 330 retrieves the intra frame and initializes the trick play decoder 350. The flow diagram ends with step 640 in which the trick play decoder 350 decodes the stored compressed bitstream to provide output image data of the compressed bitstream.

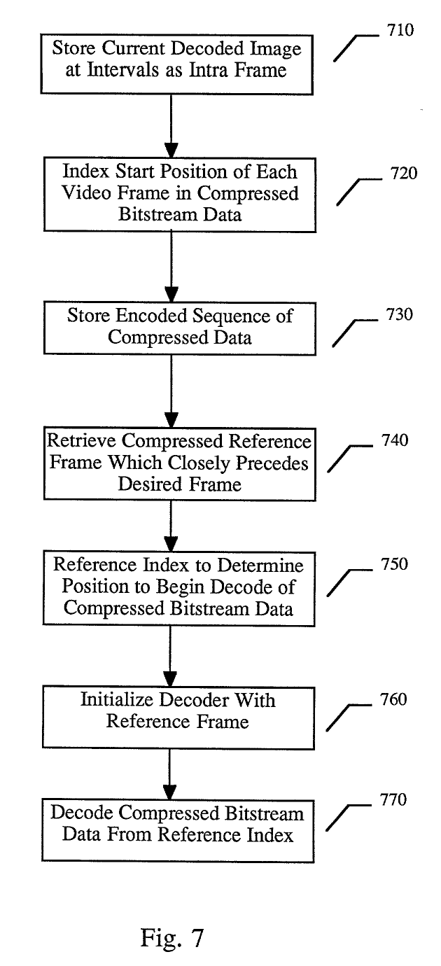

FIG. 7 illustrates a flow diagram of an embodiment for random access of a compressed bitstream. The flow diagram begins with step 710 in which the frame creator buffer 430 stores current decoded image at intervals as intra frames. Encoding and storing the decoded image as an intra frame enables the frame creator 330 to initialize the trick play decoder 350 or other standard compatible decoder with the intra frame. Step 720 provides that the indexor 520 indexes the start position of each video frame in a compressed bitstream. In step 730, the indexor 520 stores the compressed bitstream in the bitstream data store 510. Step 740 provides that the trick play controller 340 retrieves a compressed reference frame which closely precedes the desired frame. In step 750, the trick play controller 340 references an index to determine the position of an image which follows the retrieved reference frame. In step 760, the frame creator buffer 430 directs the retrieved reference frame to initialize the trick play decoder 350. The flow diagram ends with step 770 in which the trick play decoder 350 begins decoding the compressed bitstream data from the corresponding indexed image.

While the foregoing detailed description has described several embodiments of the apparatus and methods for a trick play video system in accordance with this invention, it is to be understood that the above description is illustrative only and not limiting of the disclosed invention. Obviously, many modifications and variations will be apparent to the practitioners skilled in this art. Accordingly, the apparatus and methods for a trick play video system have been provided. The trick play video system affords random access to areas of a compressed bitstream encoded with predictive deltas that relates to previously transmitted data.

What is claimed is:

1. A trick play video player for creating a compressed data stream of output image data to provide later playback of captured compressed data comprising:
a frame creator which receives output image data and creates a reference frame from the output image data; and
a data stream storage coupled to the frame creator configured to store the compressed data stream which follows the reference frame.

2. The trick play video player of claim 1, wherein the reference frame includes an intra coded frame.

3. The trick play video player of claim 2, wherein the data stream storage provides predicted compressed data in reference to the intra coded frame.

4. The trick play video player of claim 1, wherein the reference frame and the compressed data stored in the data stream storage comprise an independent data stream.

5. The trick play video player of claim 1, wherein the frame creator includes an encoder which encodes the output image data to provide an uncompressed reference frame.

6. The trick play video player of claim 1 further comprising a decoder coupled to the frame creator configured to receive an initializing reference frame and decode the compressed data stream to provide the later playback of the captured compressed data.

7. The trick play video player of claim 6 wherein:
the frame creator includes a reference frame buffer which stores a plurality of reference frames at predetermined intervals; and
the data stream storage includes an indexor which generates an index of a start position of each video frame of the compressed data stream which follows the reference frames.

8. The trick play video player of claim 7 further comprising a controller coupled to the frame creator and the data stream storage configured to select a particular reference frame and a particular index corresponding to a video frame following the particular reference frame to the decoder to provide random access of the compressed data stream.

9. A computer readable media for a trick play system which receives compressed bitstream data of images for later playback comprising:
a decoder which decodes the compressed bitstream data to provide output image data;
a frame creator coupled to the decoder which receives the output image data and creates a reference frame; and
a data stream storage coupled to the frame creator and the decoder configured to store the compressed bitstream data which follows the reference frame.

10. The computer readable media for a trick play system of claim 9, wherein the reference frame includes an intra coded frame.

11. The computer readable media for a trick play system of claim 10, wherein the data stream storage provides predicted compressed data in reference to the intra coded frame.

12. The computer readable media for a trick play system of claim 9, wherein the reference frame and the compressed bitstream data stored in the data stream storage comprise an independent data stream.

13. The computer readable media for a trick play system of claim 9, wherein the frame creator includes an encoder which encodes the output image data to provide an uncompressed reference frame.

14. The computer readable media for a trick play system of claim 9 further comprising a second decoder coupled to the frame creator configured to receive an initializing reference frame and decode the compressed bitstream data to provide the later playback of decoded images.

15. The computer readable media trick play system of claim 9 wherein:
the frame creator includes a reference frame buffer which stores a plurality of reference frames at predetermined intervals; and
the data stream storage includes an indexor which generates an index of a start position of video frames of the compressed bitstream data which follows the reference frames.

16. The computer readable media trick play system of claim 15 further comprising a controller coupled to the frame creator and the data stream storage configured to select a particular reference frame and a corresponding index to a video frame following the particular reference frame to the decoder to provide random access of the images.

17. A method of accessing compressed bitstream data having a plurality of encoded images comprising the steps:
creating a reference frame from the plurality of encoded images;
storing the compressed bitstream data which follows the reference frame; and
decoding the reference frame and the compressed bitstream data to access the plurality of encoded images.

18. The method of accessing compressed bitstream data of claim 17, wherein the step of creating a reference frame includes:
decoding the compressed bitstream data to provide a decoded image; and
encoding the decoded image as an intra coded frame.

19. The method of accessing compressed bitstream data of claim 17, wherein:
the step of creating a reference frame includes creating a plurality of reference frames at predetermined intervals; and
the step of storing the compressed bitstream data includes indexing images of the compressed bitstream data.

20. The method of accessing compressed bitstream data of claim 19 further comprising the steps:
selecting a particular reference frame; and
decoding the compressed bitstream data from a particular indexed image which follows the particular reference frame to provide random access of the encoded images.
